(19) United States
(12) Patent Application Publication
(10) Pub. No.: US 2007/0063504 A1
(43) Pub. Date: Mar. 22, 2007

(54) Vehicle chassis with removably interconnected chassis parts

(76) Inventor: Chen-Chi Hsiao, Chia Yi Hsien (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/206,890

(22) Filed: Aug. 18, 2005

(51) Int. Cl. B62D 21/00

(52) U.S. Cl. 280/781; 180/311

(57) ABSTRACT

A vehicle chassis includes a first chassis part, a second chassis part, and a coupling device. The first chassis part has an upwardly extending post. The coupling device interconnects removably the first and second chassis parts, and includes a coupling block, a spring-loaded latch unit, and a lever. The coupling block is provided on the second chassis part at a position corresponding to the post of the first chassis part. The latch unit is mounted movably on the post, and is capable of releasable engagement with the coupling block when the coupling block is brought toward the post, thereby interconnecting removably the first and second chassis parts. The lever is coupled to the latch unit, is disposed adjacent to the post, and is operable so as to disengage the latch unit from the coupling block to permit disassembling of the first and second chassis parts.

### BACKGROUND OF THE INVENTION

1. Field of the Invention

The invention relates to a vehicle chassis, more particularly to a vehicle chassis having chassis parts that can be assembled and disassembled with ease.

2. Description of the Related Art

A motor-driven vehicle for the elderly and/or the handicapped is provided with electromotive equipment on a chassis thereof. The chassis of the conventional motor-driven vehicle usually includes separable chassis parts to facilitate manufacture and transport. While many kinds of removable interconnections between chassis parts have been proposed heretofore, they involve complex manipulations that are inconvenient to conduct using one hand.

### SUMMARY OF THE INVENTION

Therefore, the object of the present invention is to provide a vehicle chassis having chassis parts that can be assembled and disassembled with ease.

Accordingly, a vehicle chassis of this invention comprises a first chassis part, a second chassis part, and a coupling device. The first chassis part has an upwardly extending post. The coupling device interconnects removably the first and second chassis parts, and includes a coupling block, a spring-loaded latch unit, and a lever. The coupling block is provided on the second chassis part at a position corresponding to the post of the first chassis part. The latch unit is mounted movably on the post, and is capable of releasable engagement with the coupling block when the coupling block is brought toward the post, thereby interconnecting removably the first and second chassis parts. The lever is coupled to the latch unit, is disposed adjacent to the post, and is operable so as to disengage the latch unit from the coupling block to permit disassembling of the first and second chassis parts.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of the preferred embodiment of a vehicle chassis according to the present invention;

FIG. 2 is a fragmentary, partly exploded perspective view of the preferred embodiment to illustrate a coupling device thereof in greater detail;

FIG. 3 is a fragmentary, schematic partly sectional view of the preferred embodiment, illustrating a state where a latch unit of the coupling device engages a coupling block;

FIG. 4 is a view similar to FIG. 3, but illustrating a state where the latch unit is disengaged from the coupling block; and

FIG. 5 is a fragmentary, partly sectional schematic top view of the preferred embodiment, illustrating one-handed operation of a lever of the coupling device for disengaging the latch unit from the coupling block.

### DETAILED DESCRIPTION OF THE PREFERRED EMBODIMENT

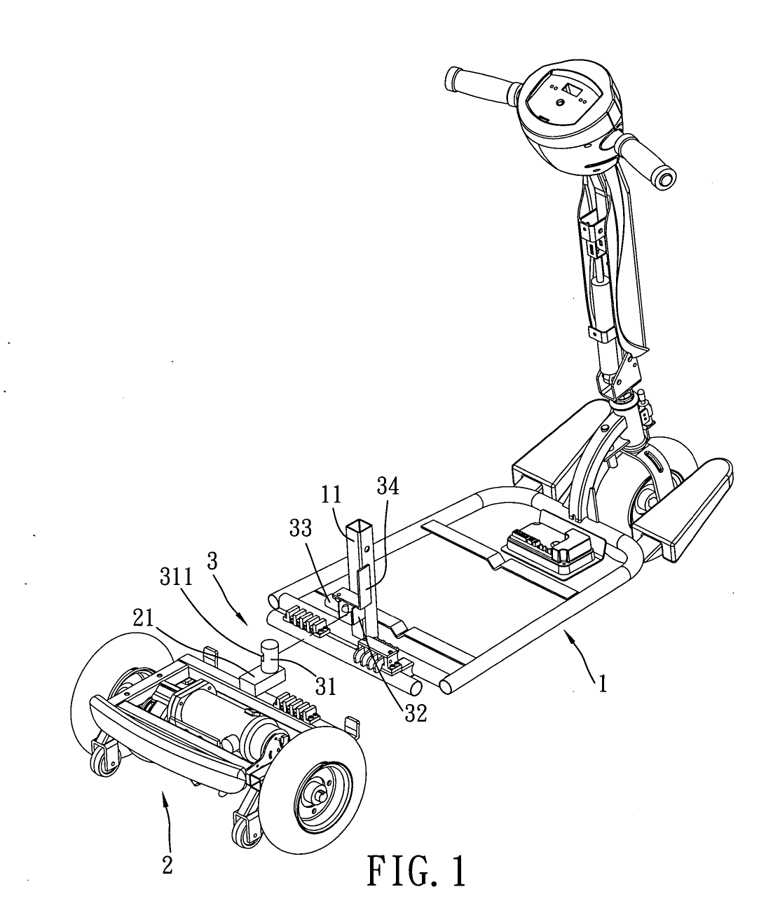

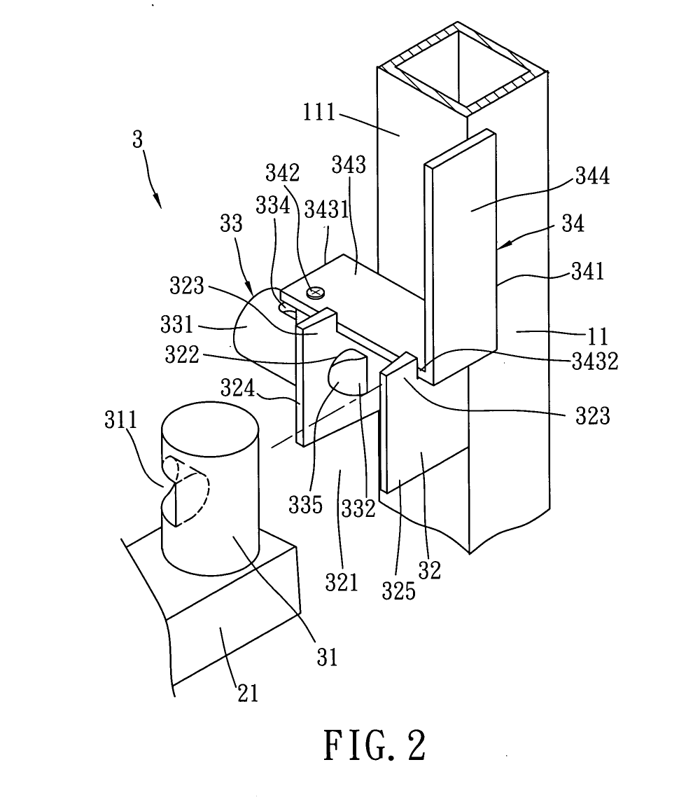

Referring to FIGS. 1 to 3, the preferred embodiment of a vehicle chassis according to the present invention is shown to include a first chassis part 1, a second chassis part 2, and a coupling device 3.

In this embodiment, the first and second chassis parts 1, 2 are front and rear chassis parts, respectively. Each of the first and second chassis parts 1, 2 is built by welding a plurality of frame rods. The first chassis part 1 has an upwardly extending post 11 that extends in a first (vertical) direction. The post 11 has a mounting side 111 that confronts the second chassis part 2. The second chassis part 2 has a horizontal frame portion 21 to be disposed adjacent to the post 11. Since the feature of the invention resides in the coupling device 3 for interconnecting removably the first and second chassis parts 1, 2, further details of the first and second chassis parts 1, 2, will be omitted herein for the sake of brevity.

The coupling device 3 includes a coupling block 31, a U-shaped bracket 32 mounted fixedly on the mounting side 111 of the post 11, a spring-loaded latch unit 33, and a lever 34.

The coupling block 31 is provided on the frame portion 21 of the second chassis part 2 at a position corresponding to the post 11 of the first chassis part 1. In this embodiment, the coupling block 31 is formed as an upright cylindrical block, and has one side formed with a latch recess 311.

The bracket 32 has first and second lateral walls 324, 325 spaced apart from each other in a second (horizontal) direction transverse to the first direction, and a connecting wall (not visible) that interconnects the lateral walls 324, 325 and that is mounted on the mounting side 111 of the post 11. The bracket 32 is formed with a bracket opening 321 that opens toward the second chassis part 2. The coupling block 31 is disposed removably in the bracket 32 via the bracket opening 321. In practice, the bracket 32 may as well be formed using a pair of plates spaced apart from each other and mounted fixedly on the mounting side 111 of the post 11. Hence, the structure of the bracket 32 should not be limited to that which is disclosed herein.

The latch unit 33 is mounted movably on the post 11, and is capable of releasable engagement with the coupling block 31 when the coupling block 31 is brought toward the post 11, thereby interconnecting removably the first and second chassis parts 1, 2. In this embodiment, the latch unit 33 includes a latching member 332 and a biasing member 333. The latching member 332 is movably disposed on the post 11, is coupled to the lever 34, and is capable of releasable engagement with the coupling block 31 at the latch recess 311. The biasing member 333 urges the latching member 332 to engage the coupling block 31 at the latch recess 311 when the coupling block 31 is brought toward the post 11. In this embodiment, the latch unit 33 further includes a latch guide 331 that extends in the second (horizontal) direction, and that is mounted on the post 11. The biasing member 333 is disposed in the latch guide 331, and is a compression spring in this embodiment. The latching member 332 extends into the latch guide 331, and is biased in the second direction by the biasing member 333.

In this embodiment, the latch guide 311 is mounted on an outer side of the first lateral wall 324. The first lateral wall 324 is further formed with a through hole 322 that permits extension of the latching member 332 in the latch guide 331 into the bracket 32 for removable engagement with the coupling block 31.

In this embodiment, the latching member 332 has a latching end part for engaging the latch recess 311 and formed with an inclined guiding end face 335. The latching member 332 is pushed by the coupling block 31 to retract into the latch guide 331 against biasing action of the biasing member 333 when the coupling block 31 is brought toward the post 11, and is biased by the biasing member 333 to engage the latch recess 311 when the latching member 332 is aligned with the latch recess 311.

The lever 34, which is coupled to the latching member 332 of the latch unit 33, is disposed adjacent to the mounting side 11 of the post 11, and is operable so as to disengage the latching member 332 from the latch recess 311 in the coupling block 31 to permit disassembling of the first and second chassis parts 1, 2. The lever 34 includes an L-shaped plate 341 and a fastener 342. The plate 341 has a first plate segment 343 that extends in the second (horizontal) direction parallel to the mounting side 111 and that has a first end 3431 adjacent to the latch unit 33 and a second end 3432 opposite to the first end 3431, and a second plate segment 344 that extends transversely from the second end 3432 of first plate segment 343. The fastener 342 connects the first end 3431 of the first plate segment 343 to the latching member 332. In this embodiment, the latch guide 331 is formed with an elongate slot 334 that extends in the second (horizontal) direction, and the fastener 342 extends through and is movable along the slot 334. Hence, the range of movement of the lever 34 in the second direction is limited by both the slot 334 and the fastener 342.

Moreover, the bracket 32 has a top end formed with a limiting portion. In this embodiment, the limiting portion includes a pair of limit tabs 323 formed respectively on top edges of the first and second lateral walls 324, 325 and spaced apart from the mounting side 111 of the post 11. The first plate segment 343 of the lever 34 is movably confined between the limit tabs 323 and the mounting side 111 of the post 11, thereby guiding movement of the first plate segment 343 in the second (horizontal) direction.

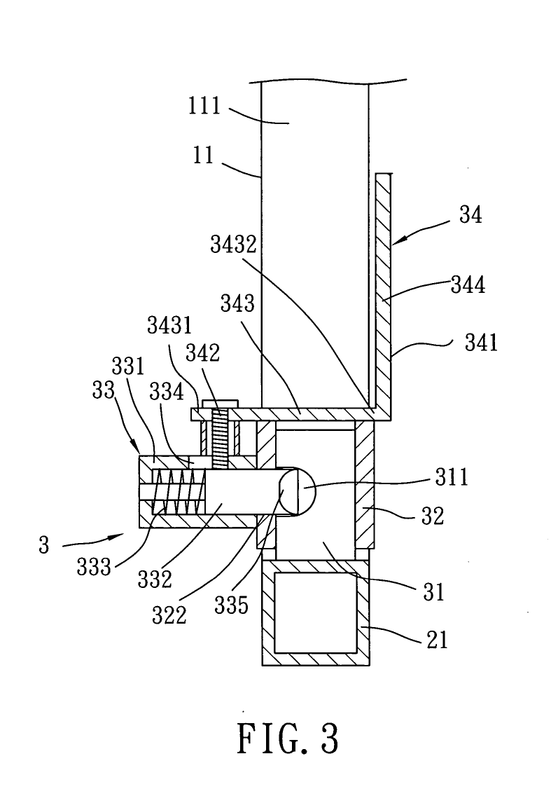

When it is desired to interconnect the first and second chassis parts 1, 2, the second chassis part 2 is brought toward the first chassis part 1 such that the coupling block 31 is moved toward the mounting side 111 of the post 11. When the coupling block 31 is extended into the bracket 32 through the bracket opening 321, the coupling block 31 initially abuts against the inclined guiding end face 335 of the latching member 332, thereby pushing the latching member 332 to retract into the latch guide 331 against biasing action of the biasing member 333. Thereafter, when the latching member 332 is aligned with the latch recess 311 in the coupling block 31, the latching member 332 is biased by the biasing member 333 to engage the latch recess 311, thereby coupling the first and second chassis parts 1, 2 together, as best shown in FIG. 3.

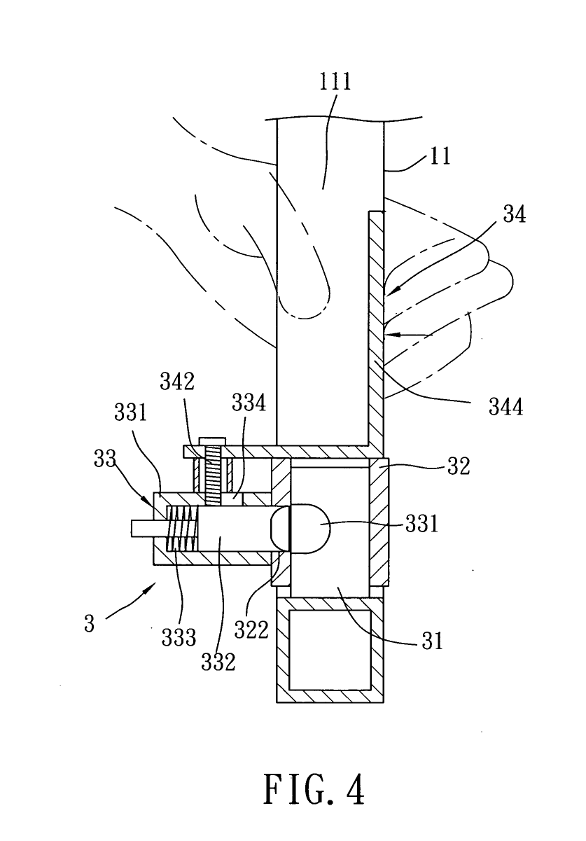

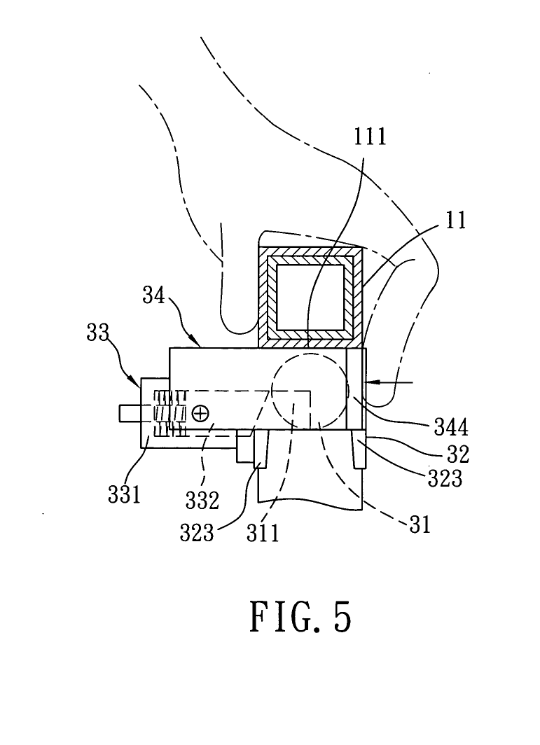

Referring to FIGS. 4 and 5, when it is desired to disassemble the first and second chassis parts 1, 2, because the lever 34 is disposed adjacent to the mounting side 111 of the post 11, the second plate segment 344 of the lever 34 can be pressed toward the latch unit 33 using one hand that grasps the post 11 so that the latching member 332 is retracted into the latch guide 331 against the biasing action of the biasing member 333, thereby disengaging the latching member 332 from the latch recess 311 in the coupling block 31 to permit disassembling of the first and second chassis parts 1, 2.

It is noted that, in other embodiments of this invention, the latch unit 33 may be mounted on the second lateral wall 325 of the bracket 32. Moreover, the position of the coupling block 31, as well as those of the bracket 32, the latch unit 33 and the lever 34, on the first and second chassis parts 1, 2 may be interchanged. In addition, the particular coupling mechanism between the lever 34 and the latch unit 33 may be varied, such as rotation of the lever 34 results in retraction of the latching member 332.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A vehicle chassis comprising:
a first chassis part having an upwardly extending post;
a second chassis part; and
a coupling device for interconnecting removably said first and second chassis parts, said coupling device including
a coupling block provided on said second chassis part at a position corresponding to said post of said first chassis part,
a spring-loaded latch unit mounted movably on said post and capable of releasable engagement with said coupling block when said coupling block is brought toward said post, thereby interconnecting removably said first and second chassis parts, and
a lever coupled to said latch unit, disposed adjacent to said post, and operable so as to disengage said latch unit from said coupling block to permit disassembling of said first and second chassis parts.

2. The vehicle chassis as claimed in claim 1, wherein said coupling block is formed with a latch recess, and said latch unit includes:
a latching member movably disposed on said post, coupled to said lever, and capable of releasable engagement with said coupling block at said latch recess; and
a biasing member for urging said latching member to engage said coupling block at said latch recess when said coupling block is brought toward said post.

3. The vehicle chassis as claimed in claim 2, wherein said post extends in a first direction, said latch unit further including a hollow latch guide that extends in a second direction transverse to the first direction and that is mounted on said post, said biasing member being disposed in said latch guide, said latching member extending into said latch guide and being biased in the second direction by said biasing member.

4. The vehicle chassis as claimed in claim 3, wherein said latch guide is formed with an elongate slot that extends in the second direction, said coupling device further including a fastener that extends through said slot, that is movable along said slot, and that fastens said lever to said latching member.

5. The vehicle chassis as claimed in claim 3, wherein said latching member is pushed by said coupling block to retract into said latch guide against biasing action of said biasing member when said coupling block is brought toward said post, and is biased by said biasing member to engage said latch recess when said latching member is aligned with said latch recess.

6. The vehicle chassis as claimed in claim 5, wherein said coupling block is formed as an upright cylindrical block, and said latching member has a latching end part for engaging said latch recess and formed with an inclined guiding end face.

7. The vehicle chassis as claimed in claim 3, wherein said coupling device further includes a U-shaped bracket having first and second lateral walls spaced apart from each other in the second direction,
said bracket being formed with a bracket opening that opens toward said second chassis part,
said coupling block being disposed removably in said bracket via said bracket opening,
said latch guide being mounted on an outer side of said first lateral wall,
said first lateral wall being formed with a through hole that permits extension of said latching member in said latch guide into said bracket for removable engagement with said coupling block.

8. The vehicle chassis as claimed in claim 2, wherein said post has a mounting side confronting said second chassis part, and said lever is disposed adjacent to said mounting side.

9. The vehicle chassis as claimed in claim 8, wherein said lever includes:
an L-shaped plate having
a first plate segment that extends in a horizontal direction parallel to said mounting side and that has a first end adjacent to said latch unit and a second end opposite to said first end, and
a second plate segment that extends transversely from said second end of first plate segment; and
a fastener for connecting said first end of said first plate segment to said latching member.

10. The vehicle chassis as claimed in claim 9, wherein said coupling device further includes a bracket mounted on said mounting side of said post, said bracket having a top end formed with a limiting portion, said first plate segment being movably confined between said limiting portion and said mounting side of said post, said limiting portion guiding movement of said first plate segment in the horizontal direction.

11. The vehicle chassis as claimed in claim 1, wherein said second chassis part has a horizontal frame portion to be disposed adjacent to said post and provided with said coupling block.
